(19) United States
(12) Patent Application Publication
(10) Pub. No.: US 2026/0244769 A1
(43) Pub. Date: Aug. 20, 2026

(54) AUTOMATICALLY DETERMINING DATA HANDLING CONTRACTS FOR RECEIVED DATA ENTITIES

(71) Applicant: MASTERCARD INTERNATIONAL INCORPORATED, PURCHASE, NY (US)

(72) Inventor: Stalin PETRONIUS, O'Fallon, MO (US)

(21) Appl. No.: 19/055,479

(22) Filed: Feb. 17, 2025

(51) Int. Cl. G06F 16/21

(52) U.S. Cl. CPC G06F 21/604; G06F 16/122; G06F 21/6245

(57) ABSTRACT

A computerized method processes newly received data entities. A data entity is received from a data entity source via an interface, and it is determined that the received data entity does not conform with stored associations between known data entities and data handling contracts. Data entity features are extracted from the received data entity, and those extracted data features are used with a trained machine learning (ML) model to determine a data entity class for the received data entity. A data handling contract associated with the data entity class is determined. Consent is requested from the data entity source and a consent response is received from the data entity source. An association between the received data entity and the determined data handling contract is then stored for use with the received data entity. The received data entity is then processed using the determined data handling contract.

### BACKGROUND

Organizations are increasingly collecting and storing large amounts of data. This data can include sensitive information, such as personally identifiable information (PII), customer data, and financial data. It is important for organizations to be able to classify and protect this data in order to comply with data privacy regulations and to prevent data breaches.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for processing newly received data entities is described. A data entity is received from a data entity source via an interface, and it is determined that the received data entity does not conform with stored associations between known data entities and data handling contracts. Data entity features are extracted from the received data entity, and those extracted data features are used with a trained machine learning (ML) model to determine a data entity class for the received data entity. A data handling contract associated with the data entity class is determined, and it is further determined that consent must be obtained from the data entity source to use the determined data handling contract. Consent is requested from the data entity source and a consent response is received from the data entity source. An association between the received data entity and the determined data handling contract is then stored for use with the received data entity and other future data entities that are similar to the received data entity. The received data entity is then processed using the determined data handling contract.

### BRIEF DESCRIPTION OF THE DRAWINGS

The present description will be better understood from the following detailed description read considering the accompanying drawings, wherein:

FIG. 1 is a block diagram illustrating an example system configured for automatically generating and establishing data handling contracts in response to receiving unclassified data entities,

FIG. 2 is a sequence diagram illustrating an example process of automatically managing the reception and processing of a new data entity by a receiving system;

FIG. 3 is a flowchart illustrating an example method for determining a data handling contract of a new data entity and processing the new data entity based on the determined data handling contract;

FIG. 4 is a flowchart illustrating an example method for processing received data entities using matching data handling contracts, including determining data handling contracts for new data entities; and

FIG. 5 illustrates an example computing apparatus as a functional block diagram.

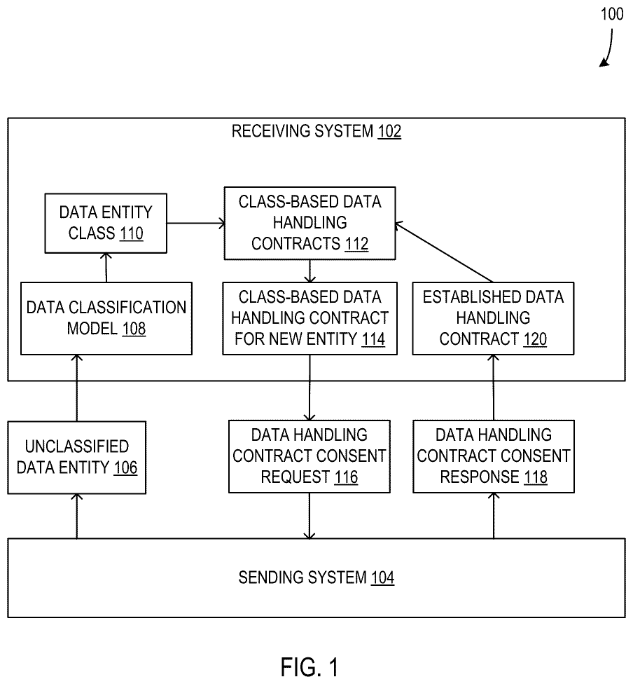

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide systems and methods that enable the automatic processing of received data entities for which processing interfaces, or data handling contracts, have not yet been defined. For instance, in an example, a medical facility receives patient information files that are of a new format or that include a new type of file. The described systems and methods analyze the new files that are not recognized and automatically determine a method by which the files should be handled based on data patterns associated with the files. A received data entity is compared to other existing relationships between data entities and data handling contracts, and it is determined that the received data entity does not conform with those existing relationships. Data features are extracted from the data entity and used with a machine learning (ML) model to determine a data entity class of the data entity. A data handling contract that is compatible with the determined data entity class is identified and consent is requested from the data entity source to use the data handling contract with the data entity and other data entities of the data entity class. Upon receiving consent, the association between the identified data handling contract and the received data entity and associated data entity class is stored for later use. The received data entity is processed according to the determined data handling contract and/or the identified data handling class.

The disclosure operates in an unconventional manner at least by automatically determining a method to process a received data entity, even when that data entity is not of a type for which a data handling contract has been established. Through the use of a trained ML model, patterns associated with the received data entity are identified and used to classify the data entity, enabling the disclosed systems and methods to accurately identify or otherwise determine a data handling contract that should be used to process the received data entity. In conventional systems that do not perform the described processes, the receipt of an unrecognized data entity results in the data entity not being processed until it is manually decided how the data entity should be treated. Further, the conventional systems need to notify and interact with the user, that result in consuming computing resources and network resources. The disclosed systems and methods reduce the time required to process a new data entity. By not wasting the computing and networking resources for interacting with the user, examples of the disclosure advantageously improve functioning of the system to use these resources for processing a greater number of data entities. Further, the described processes enhance reliability and security of such systems as well as reduce the error rate associated with manual classification of new data entities.

Aspects of the disclosed systems and methods are directed to a particular improvement managing the established data processing interfaces between two systems and processing data entities that are transferred using those data processing interfaces. Specifically, the classification of received data entities, determined data handling contracts for the entities, and consent request and response processes are performed automatically in response to the receipt of an unclassified data entity. This provides a specific improvement over prior systems by automatically predicting or otherwise determining the data handling contracts that should be used, resulting in improved data processing efficiency and security, and improved functioning of the underlying device due to the described automation, which reduces the need for manual interactions with the system and reduces the likelihood of user error. The described processes are integrated into a practical application.

FIG. 1 is a block diagram illustrating an example system 100 configured for automatically generating and establishing data handling contracts 120 in response to receiving unclassified data entities 106. In some examples, the receiving system 102 receives an unclassified data entity 106 from the sending system 104. The unclassified data entity 106 is provided to the data classification model 108, which analyzes the unclassified data entity 106 to generate or otherwise determine a data entity class 110 of the unclassified data entity 106. The data entity class 110 is used in combination with a set of class-based data handling contracts 112 to generate a class-based data handling contract 114 for the previously unclassified data entity 106. The receiving system 102 sends the generated data handling contract consent request 116 to the sending system 104 and, in response, the sending system 104 provides a data handling contract consent response 118. After the data handling contract 114 is confirmed, it is established as an established data handling contract 120 with respect to the unclassified data entity 106 and stored with the other class-based data handling contracts 112. The newly established data handling contract 120 can then be used with future data entities that are similar to and/or of the same class as the unclassified data entity 106.

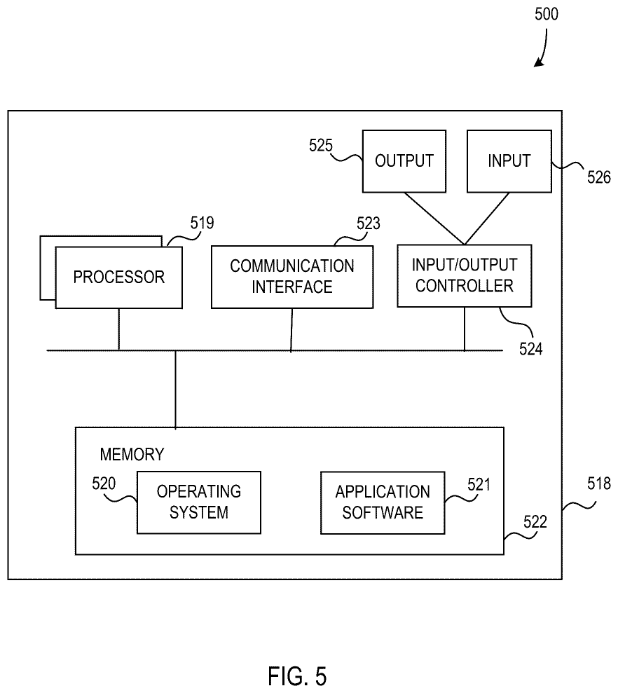

Further, in some examples, the system 100 includes one or more computing devices (e.g., the computing apparatus of FIG. 5) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the receiving system 102 is executed on a first computing device and the sending system 104 is located on a second computing device within the system 100. The first computing device and second computing device are configured to communicate with each other via network connections. Alternatively, in some examples, other components of the receiving system 102 (e.g., interfaces of the receiving system 102, the data classification model 108, and the set of class-based data handling contracts 112) are executed on separate computing devices and those separate computing devices are configured to communicate with each other via network connections during the operation of the receiving system 102. In other examples, other organizations of computing devices are used to implement system 100 without departing from the description.

In some examples, the receiving system 102 and sending system 104 are configured to communicate and/or interact by exchanging various types of data entities, such as messages, files, data streams, or the like. Each system 102 and 104 is configured to maintain methods and/or rules for handling the exchanged data entities in the form of data handling contracts (e.g., application program interfaces (APIs) or definitions thereof) such as the class-based data handling contracts 112. For instance, in an example, a data entity sent from the sending system 104 to the receiving system 102 has data security requirements such as encryption requirements, access limitation requirements, or the like. In many cases, prior to the sending system 104 sending the data entity to the receiving system 102, the sending system 104 and receiving system 102 have already agreed to and been configured to perform the necessary operations to handle the data entity (e.g., the receiving system 102 has a data handling contract that has been issued and/or approved by the sending system 104 including rules requiring the performance of encryption processes on the data entity and/or secure data storage operations to ensure that access to the data entity in storage on the receiving system 102 is limited as required).

In other examples, other types of operations, rules, or requirements are included in the data handling contracts without departing from the description. For instance, in an example, a data handling contract associated with video files includes a requirement that a received video file be compressed to a defined degree in order to preserve data storage space. Such a file compression rule has been approved by the sending system 104, which may require that the degree of compression be limited to maintain the quality of the video file. Other types of operations that are performed based on data handling contracts includes transformation or conversion of a data entity into another format, storing the data entity in multiple redundant locations, dividing a data entity into multiple parts, logging information about receiving the data entity, or the like.

The data classification model 108 includes hardware, firmware, and/or software configured to identify or determine a data entity class 110 of data entities that are provided as input. In some examples, the data classification model 108 is a trained machine learning (ML) model that has been trained to classify data entities based on one or more features of the data entities. In some such examples, a data entity is provided to the data classification model 108 as input and then the provided data entity is preprocessed to extract features that are then analyzed by the data classification model 108. Further, in some examples, the extracted features include data entity size, data entity file type, patterns of data within the data entity, the source of the data entity, the time at which the data entity was sent and/or received, and/or the presence and features of any other data entities received with the data entity being analyzed. In other examples, other types of extracted features are used without departing from the description.

Additionally, in some examples, the data classification model 108 has been trained using training data that includes previously received data entities that are associated with known data entity classes. In some such examples, training the data classification model 108 includes providing the model 108 a data entity from the training data as input and generating a data entity class 110 as output of the model 108. The generated data entity class 110 is then compared to the known data entity class with which the input data entity is associated and, if the generated data entity class and known data entity class differ, parameters and/or other aspects of the data classification model 108 are adjusted to improve its accuracy in determining data entity classes 110. Thus, after many iterations, the data classification model 108 is trained to be sufficiently accurate at determining data entity classes 110 based on provided data entities and/or associated data entity features.

In some examples, data entity classes 110 are associated with data entity file types. For instance, in an example, a data entity class 110 and associated data handling contract 112 is defined for specific types of image files, document files, audio files, or the like. Additionally, or alternatively, data entity classes 110 are associated with other aspects of the data entities, such as the content of the data entities and/or source of the data entities. For instance, in an example, a data entity class 110 and associated data handling contract 112 is defined for all data entities received from a specific sending system 104 and/or for all data entities received with a specific indicator from the specific sending system 104 (e.g., the sending system 104 is enabled to indicate when a particular sent data entity should be handled in a certain way, such as “confidential” data entities being handled differently than “public” data entities). It should be understood that, in some examples, data entity classes 110 are defined for data entities with a combination of such aspects (e.g., a data entity class 110 and associated data handling contract 112 for handling image files received from a specific sending system 104 with a specific indicator attached). In other examples, other combinations of aspects and/or features of data entities are used to classify those data entities using defined data entity classes 110 without departing from the description.

In some examples, the class-based data handling contracts 112 include information providing rules and/or methods for handling specific data entities that are received. For instance, in an example, upon receiving a data entity from the sending system 104, the receiving system 102 determines the data entity class 110 of the data entity (e.g., based on the included information in the message from the sending system 104 by which the data entity was sent) and, based on that determined data entity class 110, the receiving system 102 accesses a matching class-based data handling contract 112. The receiving system 102 then performs data handling operations on or with the received data entity as defined in the accessed data handling contract 112. For instance, in an example, the data handling contract 112 indicates a type of encryption to apply to the data entity, a subset of data in the data entity to extract, and/or a data store in which to store the data entity.

Further, in some examples, the class-based data handling contracts 112 have been established through request and response between the receiving system 102 and the sending system 104 as described herein. A data handling contract 112 stored by the receiving system 102 is specific to the sending system 104 and has been signed by, confirmed, and/or otherwise approved for use by the sending system 104. Thus, the sending system 104 is enabled to trust that sensitive data entities sent to the receiving system 102 will be handled using agreed upon methods in order to maintain security of those data entities. In some such examples, the class-based data handling contracts 112 include stored associations with data entity classes and/or other specific types of data entities. For instance, in some examples, each type of data entity is assigned a Universally Unique Identifier (UUID) which is then used to associate that type of data entity with a specific class-based data handling contract 112 as described herein. Such UUIDs are exchanged between the systems 102 and 104 when the data handling contracts 112 are initially established or at another time prior to exchange of the associated data entities.

Additionally, or alternatively, in some examples, storing the associations between class-based data handling contracts 112 and data entities includes the maintenance of a consent management database (CMD) which is used to track the consent status of each data entity. The CMD is configured to store details such as entity ID, consent request ID, consent status (e.g., pending, approved, rejected), timestamps of events associated with the data entity, and/or any other relevant metadata.

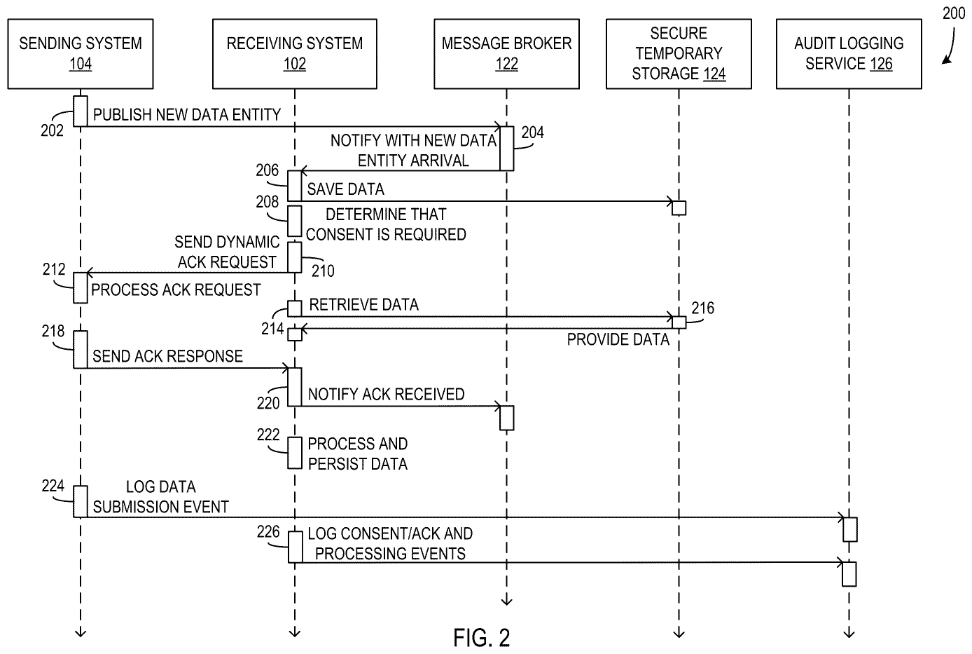

FIG. 2 is a sequence diagram illustrating an example process 200 of automatically managing the reception and processing of a new data entity by a receiving system. In some examples, the process 200 is executed or otherwise performed in a system such as system 100 of FIG. 1.

At 202, the sending system 104 publishes a new data entity (e.g., unclassified data entity 106) to a message broker 122 for consumption/use by the receiving system 102. At 204, the message broker 122 notifies the receiving system 102 about the arrival of the new data entity. In some examples, the receiving system 102 then obtains the new data entity and saves the data of the new data entity in secure temporary storage 124 at 206.

It should be understood that, in some examples, communications between the sending system 104 and the receiving system 102 include the use of mutual transport layer security (TLS) to authenticate and encrypt those communications. In such examples, both systems present certificates that are used to verify each other's identity. This verification can also be used in the described systems and methods when determining a data handling contract to use with a data entity. Additionally, or alternatively, communications and exchanges of data entities are secured using measures such as OAuth 2.0 or API keys to authenticate associated API requests. Role-based Access Controls (RBAC) may also be used to ensure that only authorized systems can access the described consent management functionality.

At 208, the receiving system 102 determines that some form of consent is required for the receiving system 102 to process the new data entity (e.g., using a determined data handling contract 114 as described herein). At 210, the receiving system 102 sends a dynamically generated acknowledgement request to the sending system 104, wherein the dynamically generated acknowledgement request includes information associated with the determined data handling contract.

At 212, the sending system 104 processes the acknowledgement request, including determining whether the use of the determined data handling contract with the new data entity should be approved or otherwise consented to. In the meantime, the receiving system 102 retrieves data of the new data entity from the secure temporary storage 124 at 214 and the secure temporary storage 124 provides the requested data at 216.

After the sending system 104 processes the acknowledgement request, at 218, the sending system 104 sends an acknowledgement response indicating consent for the receiving system to use the indicated data handling contract with the new data entity. It should be understood that, in other examples, the described processes at 214 and 216 are performed in a different order relative to the processes associated with 210, 212, 218 and 220 without departing from the description. At 220, the receiving system 102 notifies the message broker 122 that the acknowledgement has been received. In some examples, the exchange of the acknowledgement request and acknowledgement response includes the use of digital signatures between the sending system 104 and the receiving system 102, wherein each party is enabled to verify the digital signature of the other party to ensure data integrity and authenticity.

At 222, the receiving system 102 processes and persists the data. In some examples, processing and persisting the data includes performing operations required by the determined data handling contract and then storing the data of the new data entity according to the requirements of the determined data handling contract.

At 224, the sending system 104 logs the data submission event with the audit logging service 126 and, at 226, the receiving system 102 logs the consent/acknowledgement and processing events with the audit logging service 126. In some examples, the audit logging service 126 is configured to log all consent-related events, including request generation, consent/acknowledgement submission, status updates, and/or any errors or exceptions. Further, in some such examples, the audit logging service 126 includes logs that are immutable and securely stored.

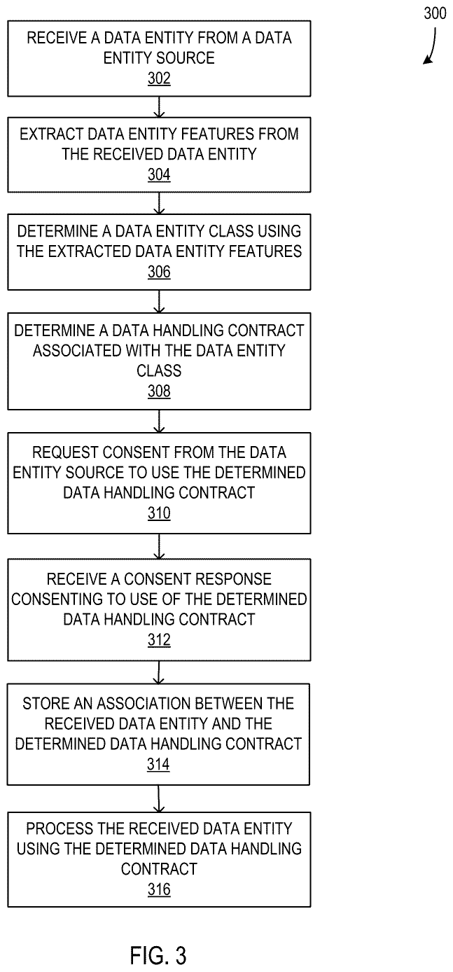

FIG. 3 is a flowchart illustrating an example method 300 for determining a data handling contract of a new data entity and processing the new data entity based on the determined data handling contract. In some examples, the method 300 is executed or otherwise performed by or in association with a system such as system 100 of FIG. 1.

At 302, a data entity is received from a data entity source. In some examples, the data entity source is a sending system such as sending system 104 and the data entity is received via an interface between the sending system and the receiving system as described herein. Further, in some examples, the received data entity includes one or more data files or other data structures of one or more types (e.g., document files, image files, audio files, or the like).

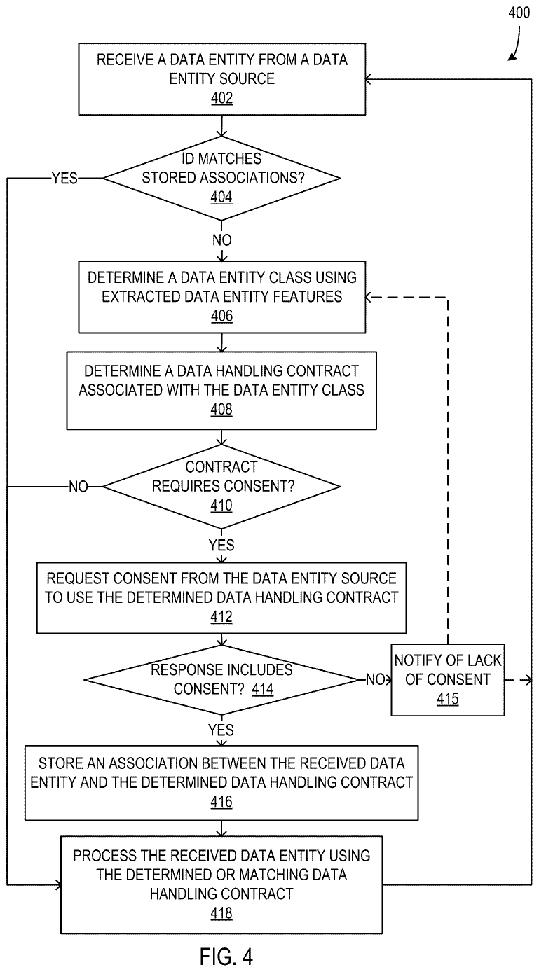

At 304, data entity features are extracted from the received data entity. In some examples, it is first determined that the received data entity is a new data entity that is not already associated with a data handling contract, as described in greater detail in the method 400 of FIG. 4. Additionally, or alternatively, the data entity features include data entity size data, data patterns in the data entity, image patterns in image files of the data entity, audio patterns in audio files of the data entity, an identifier of the data entity, the source of the data entity, datetime data associated with the data entity, and/or the like.

At 306, a data entity class is determined using the extracted data entity features. In some examples, the extracted data entity features are provided as input to a trained ML model and the trained ML model then generates the data entity class as output as described herein. Alternatively, or additionally, the determination of the data entity class is based on defined rules that are used to evaluate the data entity and/or the extracted data entity features thereof.

At 308, a data handling contract associated with the data entity class is determined. In some examples, a map, list, or group of data handling contracts and associated data entity classes is maintained such that, by using a data entity class, an associated data handling contract can be determined. Alternatively, in other examples, other methods of determining the data handling contract are used (e.g., select a data handling contract from a list of data handling contracts specific to the data entity source). Further, in some examples, the data handling contract includes data encryption indicators, storage location indicators, user access rule indicators, or the like.

At 310, consent to use the determined data handling contract is requested. In some examples, the receiving system sends a consent request, or an acknowledgement request as illustrated in FIG. 2, to the sending system. This enables the sending system to prevent the receiving system from using the determined data handling contract with the received data entity or to approve the use of the determined data handling contract with the received data entity.

At 312, a consent response is received in response to the sent consent request. In some examples, the consent response includes a consent to the use of the determined data handling contract. Alternatively, in other examples, the consent response rejects the use of the determined data handling contract.

At 314, after an affirmative consent response is received, an association between the received data entity and the determined data handling contract is stored and/or established at the receiving system. As a result of the saving of this association, the received data entity is processed using the determined data handling contract at 316. Further, in some examples, future data entities that are of the same data entity class as the received data entity and/or are otherwise sufficiently similar to the received data entity are processed using the determined data handling contract due to the saved association.

In some examples, such processing includes encryption of data of the data entity, storage of the data entity in specific location(s), transformation of data in the data entity, and/or configuration of access controls with respect to the data entity.

Further, in an example, a second data entity is received from the data entity source, and it is determined that the second data entity conforms with the stored association between the received data entity and the determined data handling contract. As a result, the second data entity is processed using the determined data handling contract.

FIG. 4 is a flowchart illustrating an example method 400 for processing received data entities using matching data handling contracts, including determining data handling contracts for new data entities. In some examples, the method 400 is executed or otherwise performed by or in association with a system such as system 100 of FIG. 1.

At 402, a data entity is received from a data entity source and, at 404, if the ID of the data entity matches a data entity ID in a set of stored associations between data entities and data handling contracts, the process proceeds to 418. Alternatively, if, at 404, the ID of the data entity does not match any data entity ID in the set of stored associations between data entities and data handling contracts, the process proceeds to 406. In some examples, the data entity ID is a UUID assigned to the data entity. Alternatively, or additionally, the data entity ID includes other data values associated with the data entity without departing from the description.

For instance, in an example, upon receiving the data entity, the UUID of the data entity is compared to UUIDs of data entities of stored associations between data entities and data handling contracts. Based on the comparisons, it is determined that the UUID of the received data entity does not match any UUIDs of the data entities of the stored association, indicating that a data entity class must be determined for the received data entity.

At 406, the data entity class is determined using extracted data entity features and, at 408, a data handling contract associated with the data entity class is determined. In some examples, the process at 406 and 408 is performed in substantially the same ways as described above with respect to FIGS. 1, 2, and 3.

At 410, if the determined data handling contract requires consent from the data entity source, the process proceeds to 412. Alternatively, if the determined data handling contract does not require consent from the data entity source, the process proceeds to 418.

At 412, consent is requested from the data entity source for permission to use the determined data handling contract with the received data entity. At 414, if a consent response is received from the data entity source approving the use of the determined data handling contract, the process proceeds to 416. Alternatively, if the data entity source rejects the use of the determined data handling contract at 414, the process proceeds to 415 where another data handling contract is selected (e.g., the process returns to 406) and/or a notification is generated for the issue to be managed by a user and/or another process.

At 416, the association between the received data entity and the determined data handling contract is stored for later use as described herein.

At 418, the received data entity is processed using the determined or matching data handling contract. If the process has come directly from 404, the matching data handling contract is used. If the process has come from 410 or 416, the determined data handling contract is used. After the received data entity is processed, the process returns 402 to receive another data entity.

### Additional Examples

In an example, a healthcare organization uses the described system to classify its patient data. The system is trained on a dataset of historical patient data that has been tagged with different privacy classifications, such as “Public,”, “Internal”, “Restricted”, “Confidential,” and “Highly Confidential.” Once the system is trained, it is used to automatically classify new patient data as it is received, applying one of the privacy classifications based on the similarity of the new patient data to historical patient data in the training set. This allows the healthcare organization to easily identify and protect its patient data.

In an example, a financial services organization uses the described system to classify its customer/employer data. The system is trained on a dataset of historical customer data that has been tagged with different privacy classifications, such as “Public,”, “Internal”, “Restricted”, “Confidential,” and “Highly Confidential.” Once the system is trained, it is used to classify new customer data. This allows the financial services organization to easily identify and protect its most sensitive customer data, such as credit card numbers and Social Security numbers. Further, the financial services organization uses the system to comply with various data privacy regulations, such as the General Data Protection Regulation (GDPR) and the California Consumer Privacy Act (CCPA).

In an example, a law firm uses the system to classify its client data. The system is trained on a dataset of historical client data that has been tagged with different privacy classifications, such as “Public”, “Internal”, “Restricted”, “Confidential”, and “Highly Confidential”. Once the system is trained, it is used to classify new client data. This allows the law firm to easily identify and protect its most sensitive client data, such as legal documents and case information.

In an example, a government agency uses the system to classify its citizen data. The system is trained on a dataset of historical citizen data that has been tagged with different privacy classifications, such as “Public”, “Internal”, “Restricted”, “Confidential”, and “Highly Confidential”. Once the system is trained, it is used to classify new citizen data. This allows the government agency to easily identify and protect its most sensitive citizen data, such as personal identification information and tax records.

In an example, the GDPR requires organizations to obtain consent from individuals before collecting and processing their personal data. The financial services organization uses the system to identify all the personal data that it is collecting from its customers. The organization then uses this information to create a dynamic consent request that the source system can acknowledge when new data is exchanged.

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, automatically classifying received data entities using a trained ML model and processing those data entities based on the classifications as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, sensor devices, Internet of Things (IoT) devices, single board computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: receive a data entity via an interface from a data entity source; determine the received data entity does not conform with stored associations between data entities and data handling contracts; extract data entity features from the received data entity; determine a data entity class for the received data entity using the extracted data entity features and a trained machine learning (ML) model; determine a data handling contract associated with the determined data entity class of the received data entity; request consent from the data entity source to use the determined data handling contract; receive a consent response consenting to use of the determined data handling contract from the data entity source; store an association between the received data entity and the determined data handling contract for use with the received data entity and future data entities that are of the data entity class as the received data entity; and process the received data entity based on the received consent response and using the determined data handling contract.

An example computerized method comprises receiving a data entity via an interface from a data entity source; extracting data entity features from the received data entity; determining a data entity class for the received data entity using the extracted data entity features and a trained machine learning (ML) model; determining a data handling contract associated with the determined data entity class of the received data entity; requesting consent from the data entity source to use the determined data handling contract; receiving a consent response consenting to use of the determined data handling contract from the data entity source; storing an association between the received data entity and the determined data handling contract for use with the received data entity; and processing the received data entity based on the received consent response and using the determined data handling contract.

One or more computer storage media having computer-executable instructions that, upon execution by a processor, case the processor to at least: receive a data entity via an interface from a data entity source; determine the received data entity does not conform with stored associations between data entities and data handling contracts; extract data entity features from the received data entity; determine a data entity class for the received data entity using the extracted data entity features and a trained machine learning (ML) model; determine a data handling contract associated with the determined data entity class of the received data entity; request consent from the data entity source to use the determined data handling contract; receive a consent response consenting to use of the determined data handling contract from the data entity source; store an association between the received data entity and the determined data handling contract for use with the received data entity and future data entities that are of the data entity class as the received data entity; and process the received data entity based on the received consent response and using the determined data handling contract.

Alternatively, or in addition to the other examples described herein, examples include any combination of the following:
wherein the determined data handling contract includes at least one of a data encryption indicator, a storage location indicator, or a user access rule indicator.
wherein the extracted data entity features include at least one of a data entity size, a data pattern in the data entity, an image pattern in an image file of the data entity, an audio pattern in an audio file of the data entity, a video pattern in a video file of the data entity, or an identifier of the data entity source.
wherein determining the data entity class of the received data entity includes determining that the received data entity is of a confidential data entity class; and wherein determining the data handling contract associated with the determined data entity class of the received data entity includes determining the data handling contract associated with the confidential data entity class that includes a data entity encryption operation and a data entity user access rule.
wherein receiving the data entity from the data entity source includes receiving a Universally Unique Identifier (UUID) associated with the received data entity; comparing the received UUID associated with the received data entity to UUIDs of data entities of stored associations between data entities and data handling contracts; and determining the received UUID associated with the received data entity is not present in the UUIDs of data entities of the stored associations between data entities and data handling contracts.
wherein receiving the data entity from the data entity source includes storing the data entity in a secure data store; and further comprising retrieving the stored data entity from the secure data store based on receiving the consent response prior to processing the retrieved data entity using the determined data handling contract.
further comprising: receiving a second data entity via the interface from the data entity source; determining the received second data entity conforms with the stored association between the received data entity and the determined data handling contract; and processing the received second data entity using the determined data handling contract.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving a data entity via an interface from a data entity source; exemplary means for extracting data entity features from the received data entity; exemplary means for determining a data entity class for the received data entity using the extracted data entity features and a trained machine learning (ML) model; exemplary means for determining a data handling contract associated with the determined data entity class of the received data entity; exemplary means for requesting consent from the data entity source to use the determined data handling contract; exemplary means for receiving a consent response consenting to use of the determined data handling contract from the data entity source; exemplary means for storing an association between the received data entity and the determined data handling contract for use with the received data entity; and exemplary means for processing the received data entity based on the received consent response and using the determined data handling contract.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system comprising:
a processor; and
a memory comprising computer program code, the memory and the computer program code configured to cause the processor to:
maintain stored associations between data entities and associated data handling contracts of data entities;
receive a data entity via an interface from a data entity source;
determine whether the received data entity conforms with a previously stored association in the maintained stored associations between the data entities and the associated data handling contracts of the data entities; and
process the received data entity by:
responsive to determining that the received data entity conforms with the previously stored association, process the received data entity based on an associated data handling contract of the previously stored association without requesting consent from the data entity source to use the data handling contract of the previously stored association; and
responsive to determining that the received data entity does not conform with the previously stored association:
extract data entity features from the received data entity;
determine a data entity class for the received data entity using the extracted data entity features as input to a trained machine learning (ML) model;
determine a data handling contract associated with the determined data entity class of the received data entity;
request consent from the data entity source to use the determined data handling contract;
receive a consent response consenting to use of the determined data handling contract from the data entity source;
store an association between the received data entity and the determined data handling contract for use with the received data entity and future data entities that have a same data entity class as the received data entity; and
process the received data entity based on the received consent response and using the determined data handling contract.

2. The system of claim 1, wherein the determined data handling contract includes at least one of a data encryption indicator, a storage location indicator, or a user access rule indicator.

3. The system of claim 1, wherein the extracted data entity features include at least one of a data pattern in the data entity, an image pattern in an image file of the data entity, an audio pattern in an audio file of the data entity, a video pattern in a video file of the data entity, or an identifier of the data entity source.

4. The system of claim 1, wherein determining the data entity class of the received data entity includes determining that the received data entity is of a confidential data entity class; and
wherein determining the data handling contract associated with the determined data entity class of the received data entity includes determining the data handling contract associated with the confidential data entity class that includes a data entity encryption operation and a data entity user access rule.

5. The system of claim 1, wherein receiving the data entity from the data entity source includes receiving a Universally Unique Identifier (UUID) associated with the received data entity, wherein the UUID associates a data entity type with a specific one of one or more data handling contracts; and
wherein determining whether the received data entity conforms with a previously stored association in the maintained stored associations between the data entities and the associated data handling contracts includes:
comparing the received UUID associated with the received data entity to UUIDs of data entities of the stored associations between the data entities and the associated data handling contracts; and
determining whether or not the received UUID associated with the received data entity is present in the UUIDs of the data entities of the maintained stored associations between the data entities and the associated data handling contracts.

6. The system of claim 1, wherein receiving the data entity from the data entity source includes storing the data entity in a secure data store; and
wherein the memory and the computer program code are configured to further cause the processor to:
retrieve the stored data entity from the secure data store based on receiving the consent response; and
process the retrieved data entity using the determined data handling contract.

7. The system of claim 1, wherein the memory and the computer program code are configured to further cause the processor to:
receive a second data entity via the interface from the data entity source;
determine the received second data entity conforms with the stored association between the received data entity and the determined data handling contract; and
process the received second data entity using the determined data handling contract.

8. A computerized method comprising:
maintaining stored associations between data entities and associated data handling contracts of the data entities;
receiving a data entity via an interface from a data entity source;
determining whether the received data entity conforms with a previously stored association in the maintained stored associations between the data entities and the associated data handling contracts of the data entities; and
processing the received data entity by:
responsive to determining that the received data entity conforms with the previously stored association, processing the received data entity based on an associated data handling contract of the previously stored association without requesting consent from the data entity source to use the data handling contract of the previously stored association; and
responsive to determining that the received data entity does not conform with the previously stored association:
extracting data entity features from the received data entity;
determining a data entity class for the received data entity using the extracted data entity features as input to a trained machine learning (ML) model;
determining a data handling contract associated with the determined data entity class of the received data entity;
requesting consent from the data entity source to use the determined data handling contract;
receiving a consent response consenting to use of the determined data handling contract from the data entity source;
storing an association between the received data entity and the determined data handling contract for use with the received data entity and future data entities that have a same data entity class as the received data entity; and
processing the received data entity based on the received consent response and using the determined data handling contract.

9. The computerized method of claim 8, wherein the determined data handling contract includes at least one of a data encryption indicator, a storage location indicator, or a user access rule indicator.

10. The computerized method of claim 8, wherein the extracted data entity features include at least one of a data pattern in the data entity, an image pattern in an image file of the data entity, an audio pattern in an audio file of the data entity, a video pattern in a video file of the data entity, or an identifier of the data entity source.

11. The computerized method of claim 8, wherein determining the data entity class of the received data entity includes determining that the received data entity is of a confidential data entity class; and
wherein determining the data handling contract associated with the determined data entity class of the received data entity includes determining the data handling contract associated with the confidential data entity class that includes a data entity encryption operation and a data entity user access rule.

12. The computerized method of claim 8, wherein receiving the data entity from the data entity source includes receiving a Universally Unique Identifier (UUID) associated with the received data entity, wherein the UUID associates a data entity type with a specific one of one or more data handling contracts; and
wherein determining whether the received data entity conforms with a previously stored association in the maintained stored associations between the data entities and the associated data handling contracts includes:
comparing the received UUID associated with the received data entity to UUIDs of data entities of the stored associations between the data entities and the associated data handling contracts; and
determining whether or not the received UUID associated with the received data entity is present in the UUIDs of the data entities of the maintained stored associations between the data entities and the associated data handling contracts.

13. The computerized method of claim 8, wherein receiving the data entity from the data entity source includes storing the data entity in a secure data store; and
further comprising retrieving the stored data entity from the secure data store based on receiving the consent response prior to processing the retrieved data entity using the determined data handling contract.

14. The computerized method of claim 8, further comprising:
receiving a second data entity via the interface from the data entity source;
determining the received second data entity conforms with the stored association between the received data entity and the determined data handling contract; and
processing the received second data entity using the determined data handling contract.

15. A computer storage medium has computer-executable instructions that, upon execution by a processor, cause the processor to at least:
maintain stored associations between data entities and associated data handling contracts of data entities:
receive a data entity via an interface from a data entity source;
determine whether the received data entity conforms with a previously stored association in the maintained stored associations between the data entities and the associated data handling contracts of the data entities; and
process the received data entity by:
responsive to determining that the received data entity conforms with the previously stored association, process the received data entity based on an associated data handling contract of the previously stored association without requesting consent from the data entity source to use the data handling contract of the previously stored association; and
responsive to determining that the received data entity does not conform with the previously stored association:
extract data entity features from the received data entity;
determine a data entity class for the received data entity using the extracted data entity features as input to a trained machine learning (ML) model;
determine a data handling contract associated with the determined data entity class of the received data entity;
request consent from the data entity source to use the determined data handling contract;
receive a consent response consenting to use of the determined data handling contract from the data entity source;
store an association between the received data entity and the determined data handling contract for use with the received data entity and future data entities that have a same data entity class as the received data entity; and
process the received data entity based on the received consent response and using the determined data handling contract.

16. The computer storage medium of claim 15, wherein the determined data handling contract includes at least one of a data encryption indicator, a storage location indicator, or a user access rule indicator.

17. The computer storage medium of claim 15, wherein the extracted data entity features include at least one of a data pattern in the data entity, an image pattern in an image file of the data entity, an audio pattern in an audio file of the data entity, a video pattern in a video file of the data entity, or an identifier of the data entity source.

18. The computer storage medium of claim 15, wherein determining the data entity class of the received data entity includes determining that the received data entity is of a confidential data entity class; and
wherein determining the data handling contract associated with the determined data entity class of the received data entity includes determining the data handling contract associated with the confidential data entity class that includes a data entity encryption operation and a data entity user access rule.

19. The computer storage medium of claim 15, wherein receiving the data entity from the data entity source includes receiving a Universally Unique Identifier (UUID) associated with the received data entity, wherein the UUID associates a data entity type with a specific one of one or more data handling contracts; and
wherein determining whether the received data entity conforms with a previously stored association in the maintained stored associations between the data entities and the associated data handling contracts includes:
comparing the received UUID associated with the received data entity to UUIDs of data entities of the stored associations between the data entities and the associated data handling contracts; and
determining whether or not the received UUID associated with the received data entity is present in the UUIDs of the data entities of the maintained stored associations between the data entities and the associated data handling contracts.

20. The computer storage medium of claim 15, wherein receiving the data entity from the data entity source includes storing the data entity in a secure data store; and
wherein the computer-executable instructions, upon execution by a processor, further cause the processor to at least:
retrieve the stored data entity from the secure data store based on receiving the consent response; and
process the retrieved data entity using the determined data handling contract.
